(19) United States
(12) Patent Application Publication
(10) Pub. No.: US 2019/0159116 A1
(43) Pub. Date: May 23, 2019

(54) NETWORK CAMP ON FOR MULTI-SIM DEVICES

(71) Applicant: QUALCOMM Incorporated, San Diego, CA (US)

(72) Inventors: Xuepan GUAN, Beijing (CN); Ta-Yan Siu, San Diego, CA (US); Tim Liou, San Diego, CA (US); Haizhou Liu, Beijing (CN); Xiaoyu Li, Beijing (CN); Lu Bai, Beijing (CN); Yan Zhang, Beijing (CN); Xiaojian Long, San Diego, CA (US); Gaoshan Li, Beijing (CN); Xiaopeng Li, Beijing (CN)

(21) Appl. No.: 16/085,534

(22) PCT Filed: Apr. 27, 2016
(86) PCT No.: PCT/CN2016/080414

§ 371 Date: Sep. 14, 2018

(51) Int. Cl. H04W 48/18; H04W 8/18; H04W 48/16; H04W 60/00

(52) U.S. Cl. CPC H04W 48/18; H04W 8/186; H04W 84/042; H04W 60/00; H04W 48/16

(57) ABSTRACT

Apparatuses and methods for a wireless communication device having a first Subscriber Identity Module (SIM) and a second SIM to manage communication via the first SIM and the second SIM, the method includes, but not limited to, registering the first subscription to a first Public Land Mobile Network (PLMN), wherein the first PLMN is associated with at least one parameter, identifying a second PLMN for the second subscription based on the at least one parameter, and registering the second subscription to the second PLMN.

### BACKGROUND

A wireless communication device, such as a mobile phone device or a smart phone, may include two or more Subscriber Identity Modules (SIMs). Each SIM may correspond to at least one subscription via a Radio Access Technology (RAT). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (CPRS), Wi-Fi, Personal Communications Service (PCS), and other protocols that may be used in a wireless communications network or a data communications network.

A Public Land Mobile Network (PLMN) may be a network operated by a Recognized Operating Agency (ROA) for providing communication services to devices registered to the PLMN. A SIM may be associated with a default PLMN called a Home PLMN (HPLMN), which may identify the PLMN in which the subscriber's default profile is held. When a multi-SIM wireless communication device is carried outside of the boundaries of the HPLMN (outside of the default/home country associated with the HPLMN), each of the two or more SIMS (subscriptions) may use a relatively long time to register to an appropriate PLMN (other than the HPLMN) upon activation. When the wireless communication device returns within the boundaries of the HPLMN, the wireless communication device may also use a relatively long time to register to the HPLMN, given that a Registered PLMN (RPLMN) currently associated with the wireless communication device is not the HPLMN. The RPLMN may be a most recent network to which the wireless communication device has successfully registered. The RPLMN may have a higher priority than the HPLMN for PLMN registration.

Conventionally in either case, when the first subscription has successfully camped and registered to the appropriate PLMN, the second subscription will nevertheless execute its own registration process. For example, the wireless communication device may search for the RPLMN, HPLMN, PLMNs on any preferred lists, PLMNs having sufficient signal quality at random, and PLMNs based on signal strength in that order of priority or in any other suitable priority. Thus, especially in multi-SIM wireless communication devices for which the registration processes for multiple subscriptions are executed, executing the registration process for each subscription may be considerably time-consuming and power-consuming.

### SUMMARY

Examples described, herein are concerned with improvements to network camp on performances in relation to roaming. In particular, the examples pertain to registration processes for two or more subscriptions as the wireless communication device roams outside of the boundaries of a Home Public Land Mobile Network (HPLMN) or returns within the boundaries of the HPLMN. The wireless communication device may have a first subscription enabled by a first SIM and a second subscription enabled by a second SIM. At least one parameter obtained for the registration and camping process of the first subscription may be used to identify an appropriate Public Land Mobile Network (PLMN) for the second subscription.

In some embodiments, a method for a wireless communication device to manage registrations for a first Subscriber Identity Module (SIM) associated with a first subscription and a second SIM associated with a second subscription includes registering the first subscription to a first PLMN, wherein the first PLMN is associated with at least one parameter, identifying a second PLMN for the second subscription based on the at least one parameter, and registering the second subscription to the second PLMN.

In some embodiments, identifying the second PLMN based on the at least one parameter includes determining at least one candidate PLMN for the second subscription and selecting the second PLMN from the at least one candidate PLMN based on the at least one parameter.

In some embodiments, one or more of the at least one candidate PLMN is determined while registering the first subscription to the first PLMN.

In some embodiments, the at least one candidate PLMN is determined from a list of currently available PLMNs, wherein the list of currently available PLMNs includes one or more of a HPLMN or Registered PLMN (RPLMN).

In some embodiments, selecting the second PLMN from the at least one candidate PLMN based on the at least one parameter includes determining whether any of the at least one candidate PLMN is associated with the at least one parameter.

In some embodiments, selecting the second PLMN from the at least one candidate PLMN based on the at least one parameter further includes selecting one of the at least one candidate PLMN as the second PLMN, wherein the second PLMN is associated with the at least one parameter.

In some embodiments, selecting the second PLMN from the at least one candidate PLMN based on the at least one parameter further includes suspending cell search for the at least one candidate PLMN other than the second PLMN in response to determining that the second PLMN is associated with the at least one parameter.

In some embodiments, selecting the second PLMN from the at least one candidate PLMN based on the at least one parameter further includes searching for at least one additional candidate PLMN in response to determining that none of the at least one candidate PLMN is associated with the at least one parameter.

In some embodiments, the method further includes suspending searching for the at least one additional candidate PLMN in response to finding an additional candidate PLMN associated with the at least one parameter.

In some embodiments, the method further includes setting the additional candidate PLMN associated with the at least one parameter as the second PLMN.

In some embodiments, the method further includes selecting a first candidate PLMN as the second PLMN in response to determining that the first candidate PLMN and a second candidate PLMN of the at least one candidate PLMN are associated with the at least one parameter.

In some embodiments, the first candidate N has a higher signal quality than that of the second candidate PLMN.

In some embodiments, the first candidate PLMN is a HPLMN associated with the second subscription and the second candidate PLMN is not the HPLMN associated with the second subscription.

In some embodiments, the method further includes selecting the second candidate PLMN as the second PLMN in response to determining that registration to the first candidate PLMN has failed.

In some embodiments, the method further includes determining the at least one parameter associated with the first PLMN in response to completing registration of the first subscription to the first PLMN.

In some embodiments, the at least one parameter includes a first Mobile Country Code (MCC).

In some embodiments, the second PLMN is associated with the first MCC.

In some embodiments, the first PLMN and the second PLMN are different PLMNs.

In some embodiments, the method further includes determining the at least one parameter associated with the first PLMN in response to activating the wireless communication device in response to power-on or disabling an airplane mode.

In some embodiments, determining the at least one parameter associated with the first PLMN in response to the first subscription is registered to the first PLMN in response to activating the wireless communication device.

In some embodiments, a wireless communication device includes sat least one radio frequency (RF) resource, a processor operably connected to said RF resource and configured to connect to a first SIM associated with a first subscription and to a second SIM associated with a second subscription, and configured to register the first subscription to a first PLMN, wherein the first PLMN is associated with at least one parameter, identify a second PLMN for the second subscription based on the at least one parameter, and register the second subscription to the second PLMN, and a memory operably connected to said processor.

In some embodiments, the processor identifies the second PLAIN based on the at least one parameter by determining at least one candidate PLMN for the second subscription and selecting the second PLMN from the at least one candidate PLMN based on the at least one parameter.

In some embodiments, the processor is configured to determine the at least one candidate PLMN from a list of currently available PLMNs, wherein the list of currently available PLMNs includes one or more of a HPLMN or RPLMN.

In some embodiments, the processor is configured to select the second PLMN from the at least one candidate PLMN based on the at least one parameter by determining whether any of the at least one candidate PLMN is associated with the at least one parameter.

In some embodiments, the processor is configured to select the second PLAIN from the at least one candidate PLMN based on the at least one parameter by selecting one of the at least one candidate PLMN as the second PLMN, wherein the second PLAIN is associated with the at least one parameter.

In some embodiments, the processor is further configured to suspend search for at least one additional candidate PLMN in response to determining that the second PLMN is associated with the at least one parameter.

In some embodiments, the processor is further configured to select a first candidate PLMN as the second PLMN based on one or more of signal quality in response to determining that the first candidate PLMN and a second candidate PLMN of the at least one candidate PLMN are associated with the at least one parameter.

In some embodiments, the at least one parameter includes at first MCC.

In some embodiments, a method for a wireless communication device to manage registrations for a first SIM associated with a first subscription and a second SIM associated with a second subscription includes determining a first MCC associated with a first PLMN on which the first subscription is registered, selecting a second PLMN from a list of candidate PLMNs associated with the second subscription based on the MCC, and registering the second subscription to the second PLMN before registering other candidate PLMNs from the list of candidate PLMNs.

In some embodiments, a wireless communication device includes at least one RF resource, a processor operably connected to said RF resource and configured to connect to a first SIM associated with a first subscription and to a second SIM associated with a second subscription, and configured to determine a first MCC associated with a first PLMN on which the first subscription is registered, select a second PLMN from a list of candidate PLMNs associated with the second subscription based on the MCC, and register the second subscription to the second PLMN before registering other candidate PLMNs from the list of candidate PLMNs, and a memory operably connected to said processor.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1A is a schematic diagram of a communication system in accordance with various embodiments.

FIG. 1B is a schematic diagram of a communication system in accordance with various embodiments.

FIG. 2 is a component block diagram of an example of a wireless communication device according to various embodiments.

FIG. 3 is a process flowchart diagram illustrating an example of a registration method according to various embodiments.

FIG. 4 is a table illustrating an example of a list of currently available PLMNs according to some embodiments.

FIG. 5 is a process flow diagram illustrating an example of a registration method according to various embodiments.

FIG. 6 is a process flow diagram illustrating an example of a registration method according to various embodiments.

FIG. 7 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device, User Equipment (UE), or Mobile Station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide users of the wireless communication devices with access to one or multiple separate mobile communication networks. The mobile communication networks may be supported by Radio Access Technologies (RATs). The wireless communication device may be configured to connect to one or more base stations via one or more RATs. Examples of RATs may include, but not limited to, Frequency Division Multiple Access (TDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (CPRS), Wi-Fi, Personal Communications Service (PCS), and other protocols that may be used in a wireless communications network or a data communications network. Each RAT may be associated with at least one subscription or SIM.

A wireless communication device provided with a plurality of SIMs and connected to two or more separate (or same) subscriptions or networks with one subscription or network being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is deactivated when the other one is in use. In another example, the MSMS communication device may be a Triple-SIM-Triple-Standby (TSTS) communication device, which includes three SIMs that may all be active on standby, where two may be deactivated when the third one is in use. In other examples, the MSMS communication device may be other suitable multi-SIM communication devices, with, for example, four or more SiMs, such that when one is in use, the others may be deactivated.

On the other hand, a wireless communication device that includes a plurality of SiMs and connects to two or more separate (or same) subscriptions or networks with two or more subscriptions or networks being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SiMs may remain active. In other examples, the MSMA communication device may be other suitable multi-SIM communication devices with four or more SIMs, all of which may be active.

Generally, examples described herein may be applicable to a MSMS wireless communication device (e.g., a DSDS wireless communication device) having at least a first SIM (associated with a first subscription) and a second SIM (associated with a second subscription). Illustrating with a non-limiting example, the embodiments may be implemented in a scenario in which registration for the first subscription may be completed before registration for the second subscription. In other embodiments, a MSMA wireless communication device that can simultaneously register both subscriptions may likewise benefit from the embodiments given that registration for one of the subscription (e.g., the first subscription) may be completed before registration for another subscription (e.g., the second subscription) so that at least one parameter obtained during the registration of the first subscription may be used for the registration for the second subscription.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless device on a network and enable communication services with the network. Because the information stored in a SIM may be the wireless device to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

Examples described herein relate to a Public Land Mobile Network (PLMN) registration process for two subscriptions in a multi-SIM wireless communication device. Generally, at least one parameter obtained for registering the first subscription to a first PLMN may be stored and used for registering the second subscription to a second PLMN. This may be applicable in any scenario in which the first subscription successfully registers (completes registration) before the second subscription.

A first scenario pertains to a wireless communication device being carried (roams to) outside of the boundaries of a Home PLMN (HPLMN). The wireless communication device may successfully register to an appropriate PLMN (i.e., a first PLMN) for the first subscription. The first PLMN may be associated with a first Mobile Country Code (MCC) which may identify the country in which the first PLMN and the wireless communication device is located. In response to the registration for the first subscription being completed, the second subscription may still he in a cell search stage. A list of at least one candidate PLMN (currently available PLMN) may already he determined for the second subscription. Instead of performing the entire registration process for the second subscription, the wireless communication device may determine whether any of the at least one candidate PLMN is associated with the first MCC.

In response to determining that at least one of the candidate PLMNs is associated with the first MCC, the wireless communication device may suspend cell searching for other PLMNs and attempt to register to the candidate PLMN having the first MCC. In some embodiments, the first MCC may be used to filter the list of candidate PLMNs by disregarding PLMNs that do not have the first MCC. Such embodiments effectively narrow the scope of search in registering to the appropriate PLMN for the second subscription, thus conserving power and time.

A second scenario pertains to the wireless communication device being brought back into (roams back to) the home country (within the boundaries of the HPLMN) from a foreign location outside the boundaries of the HPLMN. Similarly, when the wireless communication device successfully registers to the first PLMN (e.g., now the HPLMN) for the first subscription, a first MCC corresponding to the first PLMN can be used for the registration process of the second subscription. In particular, if any of the at least one candidate PLMN has the same MCC (e.g., the first MCC) as the first PLMN, the wireless communication device may suspend cell searching for other PLMNs and initiate registration to the candidate PLMN with the first MCC.

In some embodiments, in response to determining that the first MCC is associated with the HPLMN, the wireless communication device may prioritize registering on the HPLMN when at least another candidate PLMN with the first same MCC is found. In some embodiments, when multiple candidate PLMNs are associated with the first MCC, those candidate PLMNs with the first MCC may be sorted based on suitable criteria such as, but not limited to, signal quality/strength. A PLMN with higher signal quality/strength may be attempted before another that has lower signal quality/strength.

Such parameter sharing may occur after registration of the first subscription has been completed. That is, the first MCC may be shared after registration of the first subscription is completed, as opposed to before registration completion. This may be due to the fact that before registration completion, the wireless communication device may be at an edge of a cell as the wireless communication device is leaves or enters the cell. This may lead to low signal quality/strength. MCC obtained before registration completion may not be accurate due to low signal quality/strength.

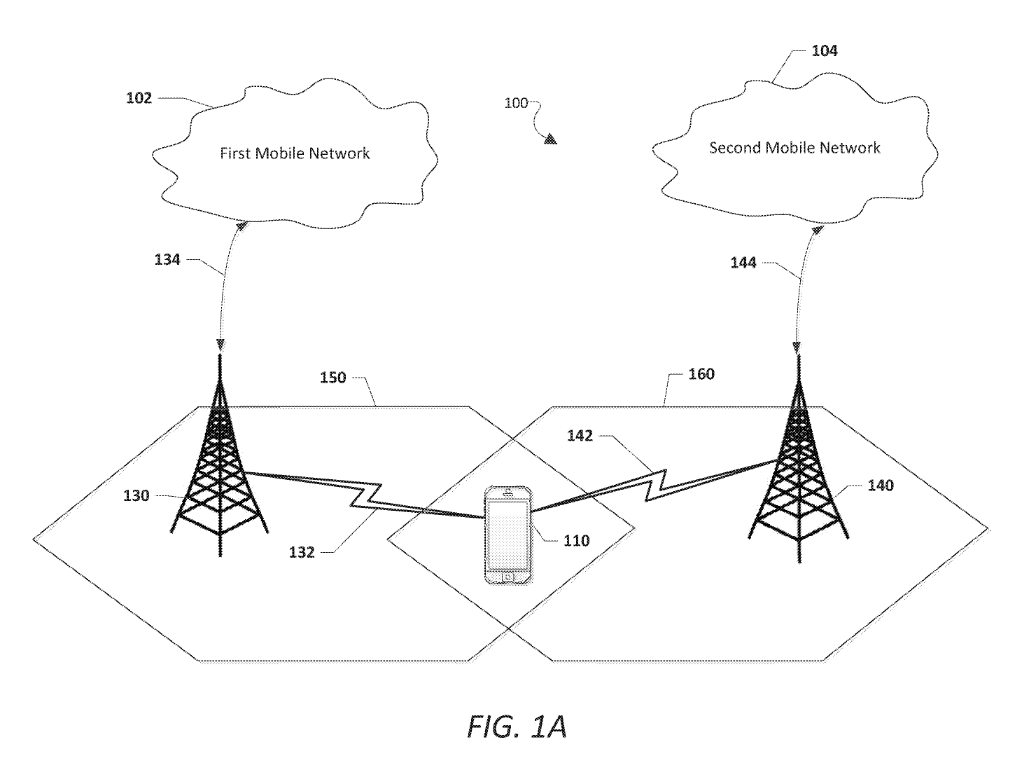

Various embodiments may be implemented within a communication system 100, an example of which is illustrated in FIG. 1A. Referring to FIG. 1A, a first mobile network 102 and a second mobile network 104 may each associate with a plurality of cellular base stations (e.g., a first base station 130 and a second base station 140, respectively). The first base station 130 may broadcast the first mobile network 102 in a first serving cell 150. The second base station 140 may broadcast the second mobile network 104 in a second serving cell 160. Illustrating with a non-limiting example, the first mobile network 102 may be associated with a first PLMN. The second mobile network 104 may be associated with a second PLMN. A wireless communication device 110 may be within effective boundaries of both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may also be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by any suitable protocol including, but not limited to, FDMA, TDMA, CDMA (e.g., EVDO), UMTS (e.g., WCDMA, LTE, HSDPA, or the like), GSM, 1×, CPRS, Wi-Fi, PCS, and/or another protocol used in a wireless communications network or a data communications network.

Each of the first base station 130 and the second base station 140 may include at least one antenna group or transmission station located in the same or different areas The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second. cellular connection 142). When a SIM is inserted, the wireless communication device 110 may access the mobile communication network associated with that SIM (and the corresponding subscription) based on the information stored on the SIM through registration, as described herein.

While the wireless communication device 110 is shown connected to the mobile networks 102 and 104 via two cellular connections, in other embodiments (not shown), the wireless communication device 110 may establish additional network connections using at least one additional RAT.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”), in some embodiments, the wireless communication device 110 may establish a wireless connection with a wireless access point (not shown), such as over a Wi-Fi connection. The wireless access point may be configured to connect to the Internet or another network over a wired connection.

FIG. 1B shows another aspect of the communication system 100 in accordance with various examples. Referring to FIGS. 1A and 1B, the first cell 150 and the second cell 160 may be within a first area 170. In other words, the first mobile network 102 (e.g., the first PLMN) and the second mobile network 104 (e.g., the second PLMN) may be associated with the first area 170. The first area 170 may be associated with a first MCC. Thus, the first PLMN and the second PLMN may be associated with the same MCC (e.g., the first MCC). The wireless communication device 110 may be carried into the first area 170 from a second area 175. Each of the first area 170 and the second area 175 may be defined by suitable boundaries such as, but not limited to, country boundaries. In other words, the first area 170 may represent a first country. The second area 175 may represent a second country. The second area 175 may be associated with a MCC different from the first MCC.

Examples described herein may be implemented in at least two scenarios. In a first scenario, the second area 175 may represent a home country that is associated with the HPLMN of the first subscription and the second subscription. The wireless communication device 110 may be carried from the second area 175 to the first area 170 (e.g., via international travel). Upon first activation of the wireless communication device 110 and before any registration processes take place in the first area 170, each of the first subscription and the second subscription may have a registered PLMN (RPLMN) that is the same as the HPLMN. Conventionally, the wireless communication device 110 may attempt to register on the HPLMN for the first subscription and the second subscription upon activation (but will be unsuccessful).

In a second scenario, the first area 170 may represent a home country that is associated with the HPLMN of the first subscription and the second subscription. The wireless communication device 110 may be carried from the second area 175 to the first area 170 (e.g., via international travel). Upon first activation of the wireless communication device 110 and before any registration processes take place in the first area 170, each of the first subscription and the second subscription may be associated with a RPLMN of the second area 175 that is not the HPLMN. Conventionally, the wireless communication device 110 may attempt to register on the RPLMN for the first subscription and the second subscription upon activation (but will be unsuccessful).

In either scenario, the wireless communication device, 110 may attempt to register to a PLMN that is not associated with the current geological location that the wireless communication device 110 is at. Thus, examples described herein relate to expediting the registration process for at least the second subscription by using at least one parameter (e.g., the first MCC) obtained during registration of the first subscription. Accordingly, registration attempts to inappropriate PLMNs not associated with the first MCC may be avoided, for the second subscription. As used herein, the first area 170 may refer to an area in which the wireless communication device 110 is currently located, and the second area 175 may refer to an area in which the wireless communication device was previously located (before the activation of the wireless communication device 110 in the first area 170).

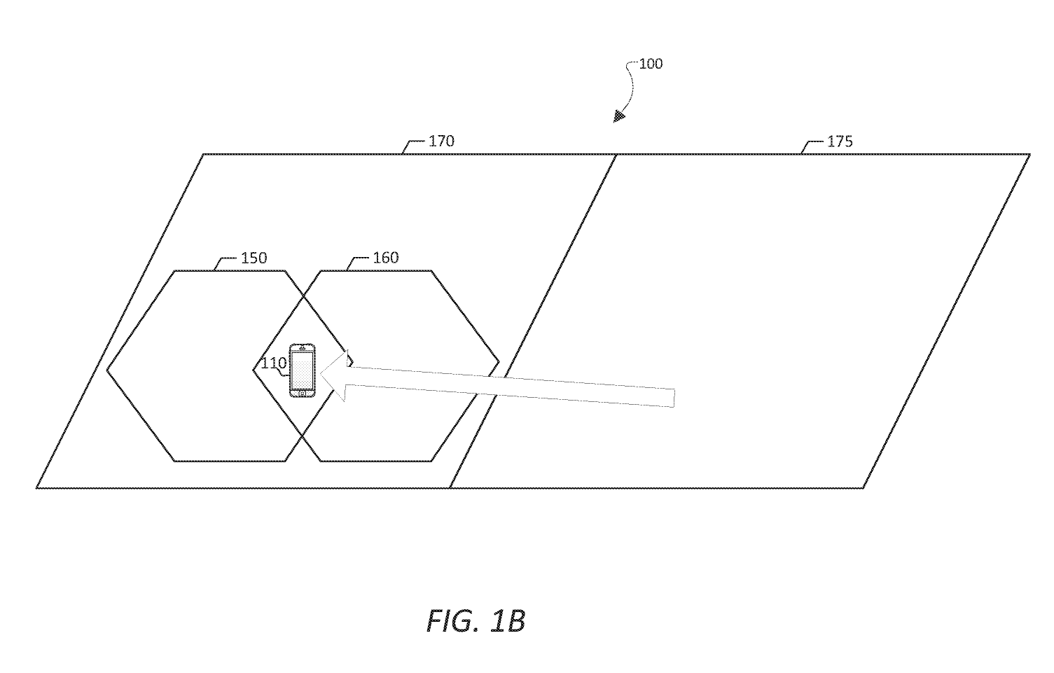

FIG. 2 is a functional block diagram of a wireless communication device 200 suitable for implementing various embodiments. According to various embodiments, the wireless communication device 200 may be the wireless communication device 110 as described with reference to FIGS. 1A and 1B. Referring to FIGS. 1A-2, the wireless communication device 200 may include a first SIM interface 202a, which may receive a first identity module SIM-1 204a that is associated with the first subscription (corresponding to the first mobile network 102 or first PLMN). The wireless communication device 200 may also include a second. SIM interface 202b, which may receive a second identity module SIM-2 204b that is associated with the second subscription (corresponding to the second mobile network 104 or second PLAIN).

A SIM (e.g., SIM-1 204a, SIM-2 204b, and/or the like) in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as welt as provide storage space for phone book database of the user's contacts. As part of the network provisioning information, a SIM may store home identifiers (e.g., a System Identification Number (SID)/Network Identification Number (NID) pair, a HPLMN code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, RAM, ROM, floppy disks, hard disks, dangles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RE resource chain. A baseband-RE resource chain may include the baseband modem processor 216, which may perform baseband/modem functions for communications on the SIMs. The baseband modem processor 216 may include one or more amplifiers and radios, referred to generally herein as a RF resource 218 or RE chain.

The examples described herein may be applicable to wireless communication devices in which the SIMs 204a and 204b share a common set of RE resource (particularly, the RE resource 218). Examples described herein may also be applicable to wireless communication devices in which each of the SIMs 204a and 204b has a separate RE resource.

The RF resource 218 may include at least one transceiver that perform transmit/receive functions for the associated. SIMS 204a and 204b of the wireless communication device 200. The RE resource 218 may include separate transmit and receive circuitry, or may include a transceiver that combines transmitter and receiver functions. The RF resource 218 may be coupled to a wireless antenna 220. The RE resource 218 may also be coupled to the baseband modem processor 216.

In some examples, the general-purpose processor 206, the memory 214, the baseband modem processor 216, and the RE resource 218 may be included in the wireless communication device 200 as a system-on-chip. In some embodiments, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include a registration module 230 configured to register SIM-1 204a (the first subscription) and SIM-2 204b (the second subscription) to the appropriate PLMN in the manner described.

In some embodiments, the registration module 230 may be implemented within the general-purpose processor 206. For example, the registration module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the registration module 230. For example, the registration module 230 may be implemented as a separate processing component (i.e., separate from the general-purpose processor 206). The registration module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In some embodiments, the wireless communication device 200 may include, among other things, additional SIM cards, SIM interfaces, at least another RF resource associated with the additional SIM cards, and additional antennas for connecting to additional mobile networks.

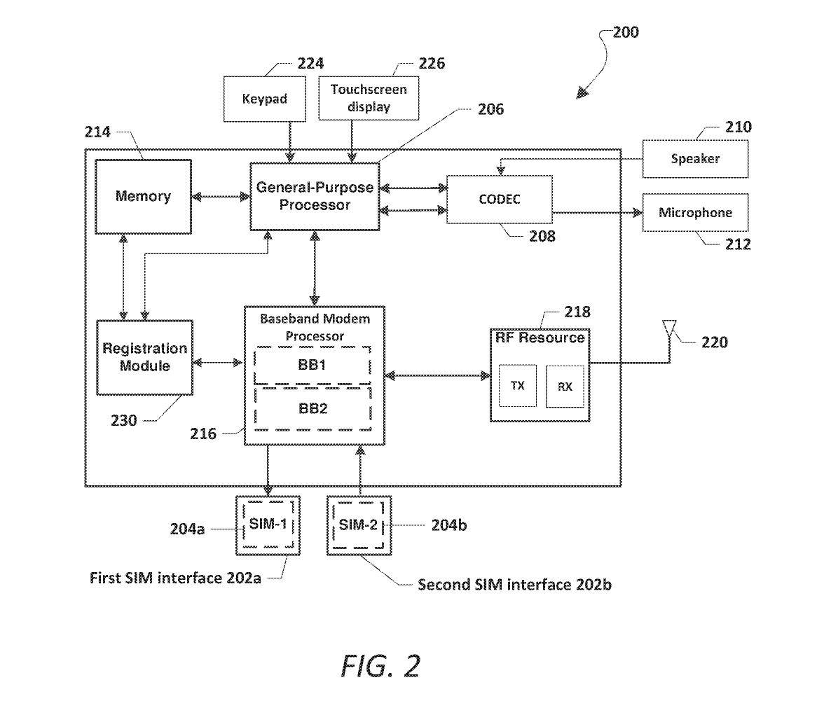

FIG. 3 is a process flowchart diagram illustrating an example of a registration method 300. Referring to FIGS. 1A-3, in some examples, the registration module 230 or the general-purpose processor 206 may register the first subscription to the first PLMN, at block B310. The first PLMN is associated with at least one parameter. In some examples, the at least one parameter may include a first MCC. The registration module 230 or the general-purpose processor 206 may register the first subscription to the first PLMN in response to the wireless communication device being activated by powering on (power-on) or disabling an airplane mode (airplane mode off).

At block B320, the registration module 230 or the general-purpose processor 206 may identify one or more candidate PLMNs for the second subscription based on the at least one parameter (e.g., such as, but not limited to, the first MCC). In some embodiments, the registration module 230 or the general-purpose processor 206 may determine the one or more candidate PLMNs in response to completing registration of the first subscription to the first PLMN.

The one or more candidate PLMNs may correspond to a list of currently available PLMNs saved in the memory 214 of the wireless communication device 200 or the second SIM (SIM-2 2046). The currently available PLMNs may include, but not limited to, the HPLMN, RPLMN, or any PLMNs associated with the second subscription. For example, any PLMNs associated with the second subscription found through cell search before completing registering the first subscription to the first PLMN or while registering the first subscription to the first PLMN may be included in the list of currently available PLMNs. The list of currently available PLMNs may be expanded to include at least one additional candidate PLMN (found through further cell search) after the completing the registration to the first PLMN in the manner described.

In some embodiments consistent with the first scenario, the RPLMN in the list of currently available PLMNs may be the same as the HPLMN if the wireless communication device 200 was previously in the home country (e.g., the second area 175) before roaming to and activating in a foreign country (e.g., the first area 170). some embodiments consistent with the second scenario, the RPLMN in the list of currently available PLMNs may be different from the HPLMN if the wireless communication device 200 was previously in a foreign country (e.g., the second area 175) before roaming to and activating in the home country (e.g., the first area 170).

In some embodiments, the currently available PLMNs may include any PLMNs saved before or after roaming to the area in which the wireless communication device 200 is currently located (e.g., the first area 170). The first PLMN and the second PLMN may be different PLMNs.

In some embodiments, the registration module 230 or the general-purpose processor 206 may determine whether any of the at least one candidate PLMN has the same MCC (e.g., the first MCC) and the first PLMN. The candidate PLMN that is associated with the first MCC may be identified to be the second PLMN. In response to determining that two or more candidate PLMNs (e.g., a first candidate PLMN and a second candidate PLMN) are associated with the first MCC, registration module 230 or the general-purpose processor 206 may prioritize registration for (e.g., may first register) one of the two or more candidate PLMNs based on one or more of signal quality, signal strength, whether any of the two or more candidate PLMNs is associated with the HPLMN, and/or the like. Thus, at block B325, registration is prioritized for the one or more candidate PLMNs.

Illustrating with a non-limiting example in which the first candidate PLMN has a higher Received Signal Strength Indicator (RSSI) than that of the second candidate PLMN, the first candidate PLMN may be set as the second PLMN. Illustrating with another non-limiting example in which the first candidate PLMN is associated with the HPLMN and the second candidate. PLMN is not associated with the HPLMN, the first candidate PLMN may be set as the second PLMN.

In response to determining that the second PLMN is associated with the first MCC, the registration module 230 or the general-purpose processor 206 may suspend cell searching for any candidate PLMN (e.g., the HPLMN and/or RPLMN, if different from the second RPLMN) other than the second PLMN. In some embodiments, the registration module 230 or the general-purpose processor 206 may suspend searching/discovery additional candidate PLMNs further to the list of currently available PLMNs in response to determining that at least one (e.g., the second PLMN) of the candidate PLMNs is associated with the first MCC.

At block B330, the registration module 230 or the general-purpose processor 206 may register the second subscription to the second PLMN in some embodiments. In response to determining that registration to the second PLMN is unsuccessful, the registration module 230 or the general-purpose processor 206 may select another candidate PLMN as the second PLMN (e.g., at block B320) and attempt registration (at block B330). Illustrating with a non-limiting example in which at least the first and second candidate PLMN are associated with the first MCC, the second candidate PLMN may be set as the second PLMN for registration at block B330 in response to determining that registration to the first candidate PLMN (e.g., a previous second PLMN) is unsuccessful.

In some embodiments, the registration module 230 or the general-purpose processor 206 may configure the wireless communication device 200 to search for additional candidate PLMNs using the first MCC if the at least one candidate PLMN does not include any PLMN with the first MCC or if registration attempts made for all candidate PLMN(s) with the first MCC are unsuccessful.

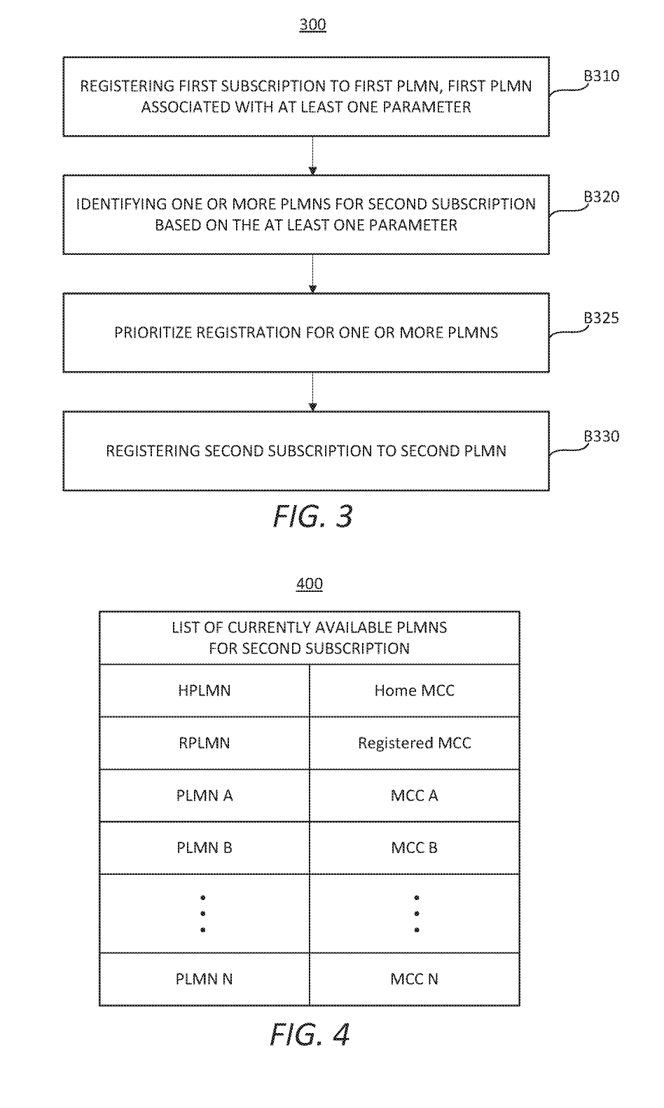

FIG. 4 is a table 400 illustrating an example of a list of currently available PLMNs for the second subscription according to some embodiments. Referring to FIGS. 1A-4, the list of currently available PLMNs may be stored in the memory 214 and may form a basis for the at least one candidate PLMNs from which the second PLMN may be selected. For example, each PLMN in the list of currently available PLMNs may be a candidate PLMN. In some embodiments, the list of currently available PLMNs for the second subscription may be stored in SIM-2 204b (the second SIM). The list of currently available PLMNs may include the HPLMN associated with a home MCC in come embodiments.

The list of currently available PLMNs may include the RPLMN associated with a registered MCC in some embodiments. The RPLMN and the registered MCC may be the same as the HPLMN and the home MCC, respectively, if the wireless communication device 200 camped on the HPLMN before current activation. The RPLMN and the registered MCC may be different from the HPLMN and the home MCC, respectively, if the wireless communication device 200 camped on a PLMN different from the HPLMN before the current activation.

The list of currently available PLMNs may additionally include at least one PLMN (PLMN A, PLMN B, . . . , PLMN N, and/or the like) saved to the memory 214 and/or the second SIM prior to completion of registration for the first subscription for any suitable reason. Illustrating with a non-limiting example, some of the PLMNs A-N may be PLMNs that the wireless communication device 200 had previously camped on. Illustrating with another non-limiting example, some of the PLMNs A-N may be PLMNs discovered while performing registration for the first subscription or during previous PLMN discovery/registration processes before the completion of registration for the first subscription. Illustrating with yet another non-limiting example, some of the PLMNs A-N may be PLMNs on a preferred list stored.

In a MSMS wireless communication device, the RF resource 218 may be shared between the first subscription and the second subscription. Thus, when the registration for the first subscription has been completed, the second subscription may not have had the chance to use the RF resource 218 following the current activation. Conventionally, cell searches for the PLMNs in the list of currently available PLMNs may be conducted according to certain priority protocol. For example, the RPLMN may be attempted before the HPLMN, which may be attempted before all other PLMNs A-N. In another example, the HPLMN may be attempted before the RPLMN, which may be attempted before all other PLMNs A-N.

Embodiments described herein seek to filter the list of currently available PLMNs for the second subscription based on the first MCC associated with the first PLMN of the first subscription to avoid unnecessary cell searches and registration attempts. Illustrating with a non-limiting example, in response to determining that MCC B is the same as the first MCC, the registration module 230 or the general-purpose processor 206 may suspend cell search for the HPLMN and/or RPLMN and initiate registration process on PLMN B, which corresponds to the MCC B (the first MCC). Thus, unnecessary cell searches and registration attempts on the HPLMN, RPLMN, and/or other PLMNs not associated with the first MCC may be avoided.

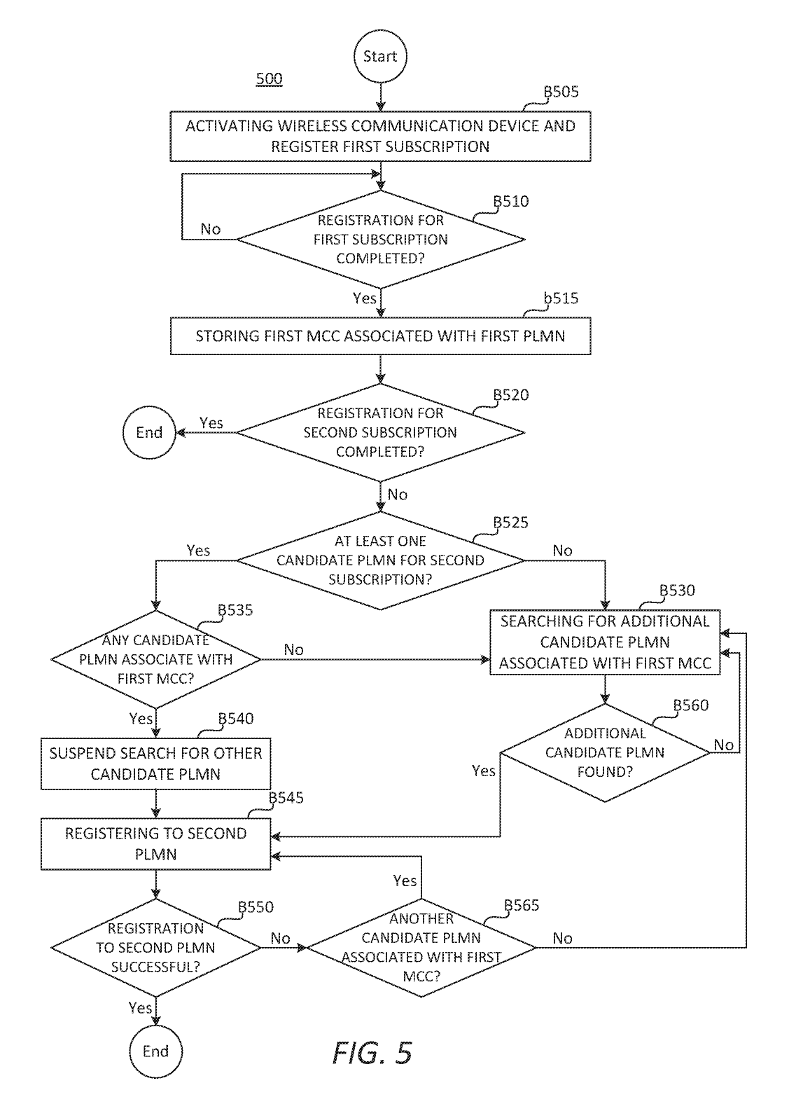

FIG. 5 is a process flow diagram illustrating an example of a registration method 500 according to various embodiments. Referring to FIGS. 1A-5, one or more blocks B505-B560 may correspond to one of blocks B310-B330. The wireless communication device 200 may be activated (e.g., powered on, flight-mode disabled, or the like) at block B505 in any suitable manner. The registration module 230 or the general-purpose processor 206 may be configured to begin registration of the first subscription. At block B510, the registration module 230 or the general-purpose processor 206 may determine whether registration for the first subscription has been completed. In response to determining that registration for the first subscription has not been completed (B510:NO), the registration module 230 or the general-purpose processor 206 may continue the registration of the first subscription.

In response to determining that registration for the first subscription has been completed (B510: YES) and the first subscription has been successfully registered to the first PLMN associated with the first MCC, the registration module 230 or the general-purpose processor 206 may store the first MCC associated with the first PLMN in the memory 214 at block B515.

At block B520, the registration module 230 or the general-purpose processor 206 may determine whether registration for the second subscription has been completed in some embodiments. In response to determining that registration for the second subscription has been completed (B520:YES), the method 500 ends. Illustrating with non-example, a MSMA device (as the wireless communication device 200) may enable simultaneous registration of the first subscription and the second subscription, thus enabling the possibility that registration for the second subscription may end at the same time. A MSMS device (as the wireless communication device 200) may share the RF resource 218 (one subscription may use the RF resource 218 at a given time), thus the second subscription typically may not complete its registration given that the first subscription has been using the RF resource 218. As used herein, any subscription that completes registration prior in time may be referred to as the first subscription.

In response to determining that the that registration for the second subscription has not been completed (B520:NO), the registration module 230 or the general-purpose processor 206 may determine whether at least one candidate PLMN for the second subscription is present, at block B525. The at least one candidate PLMN may include any PLMN in the list of currently available PLMNs. In response to determining that at least one candidate PLMN for the second subscription is present (B525:YES), the registration module 230 or the general-purpose processor 206 may determine whether any of the at least one candidate PLMN is associated with the first MCC at block B535. In other embodiments, the block B525 may be optional given that it is assumed that at least one candidate PLMN (e.g., the HPLMN) may be present (i.e., B520:NO leads directly to B535).

In response to determining that one (e.g., the second PLMN) of the at least one candidate PLMN is associated with the first MCC (B535:YES), the registration module 230 or the general-purpose processor 206 may suspend cell search for other candidate PLMN(s) (e.g., the HPLMN, RPLMN, or any candidate PLMN that is not the second PLMN) at block B540. At block B545, the registration module 230 or the general-purpose processor 206 may register the second subscription to the second PLMN in some embodiments. At block B550, the registration module 230 or the general-purpose processor 206 may determine whether registration to the second PLMN is successful.

In response to determining that registration to the second PLMN is successful (B550:YES), the method 500 ends. On the other hand, in response to determining that the registration to the second PLMN is unsuccessful (B550:NO), the registration module 230 or the general-purpose processor 206 may determine whether there is another candidate PLMN (e.g., the second candidate PLMN) that is associated with the first MCC, at block B555. In response to determining that there is another candidate PLMN that is associated with the first MCC(B555:NO), the registration module 230 or the general-purpose processor 206 may set that candidate PLMN as the second PLMN and register to the (new) second PLMN at block B545.

In response to determining that one candidate PLMN for the second subscription is present (B525:NO), in response to determining that none of the candidate PLMNs is associated with the first MCC (B535:NO), or in response to determining that there is not another candidate PLMN associated with the first MCC (B555:NO), the registration module 230 or the general-purpose processor 206 may search or discover at least one additional candidate PLMN associated with the first MCC at block B530. The registration module 230 or the general-purpose processor 206 may disregard PLMNs found that are not associated with the first MCC.

At block B560, the registration module 230 or the general-purpose processor 206 may determine whether at least one additional candidate PLMN associated with the first MCC is found. In response to determining that at least one additional candidate PLMN associated with the first MCC is found (B560:YES), the registration module 230 or the general-purpose processor 206 may set the additional candidate PLMN as the second PLMN for registration at block B545. On the other hand, in response to determining that at least one additional candidate PLMN associated with the first MCC is not found (B560:NO), the registration module 230 or the general-purpose processor 206 may continue the search/discovery at block B530.

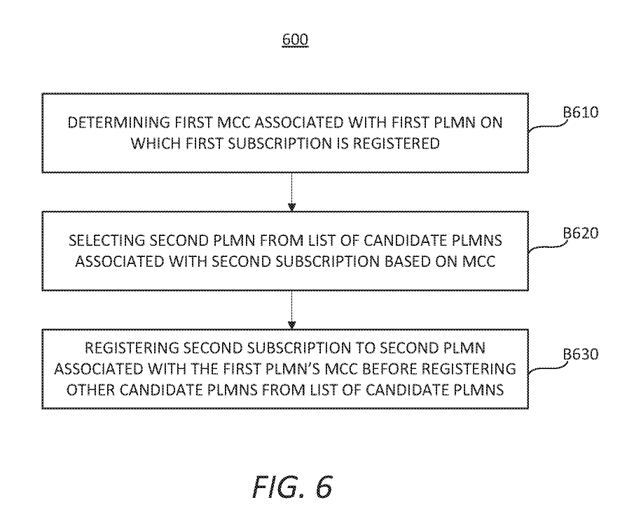

FIG. 6 is a process flow diagram illustrating an example of a registration method 600 according to various embodiments. Referring to FIGS. 1A-6, the registration module 230 or the general-purpose processor 206 may determine the first MCC associated with the first PLMN (e.g., the first mobile network 102) on which the first subscription is registered. At block B620, the registration module 230 or the general-purpose processor 206 may select the second PLMN from the list of candidate PLMNs associated with the second subscription based on the first MCC. The list of candidate PLMNs may correspond to the list of currently available PLMNs.

At block B630, the registration module 230 or the general-purpose processor 206 may register the second subscription to the second PLMN associated with the first PLMN's MCC before registering other candidate PLMNs from the list of candidate PLMNs. Illustrating with a non-limiting example in which the list of candidate PLMNs includes the HPLMN, RPLMN, and PLMNs A-N (as shown in FIG. 4), PLMN B may be selected as the second PLMN and registered before the HPLMN, RPLMN, and PLMNs A, C-N, if MCC B is the same as the first MCC. In response to determining that two or more of the candidate PLMNs are associated with the first MCC, registration to the candidate PLMNs associated with the first MCC may be attempted before other candidate PLMNs not associated with the first MCC and/or before searching/discovering additional candidate PLMNs.

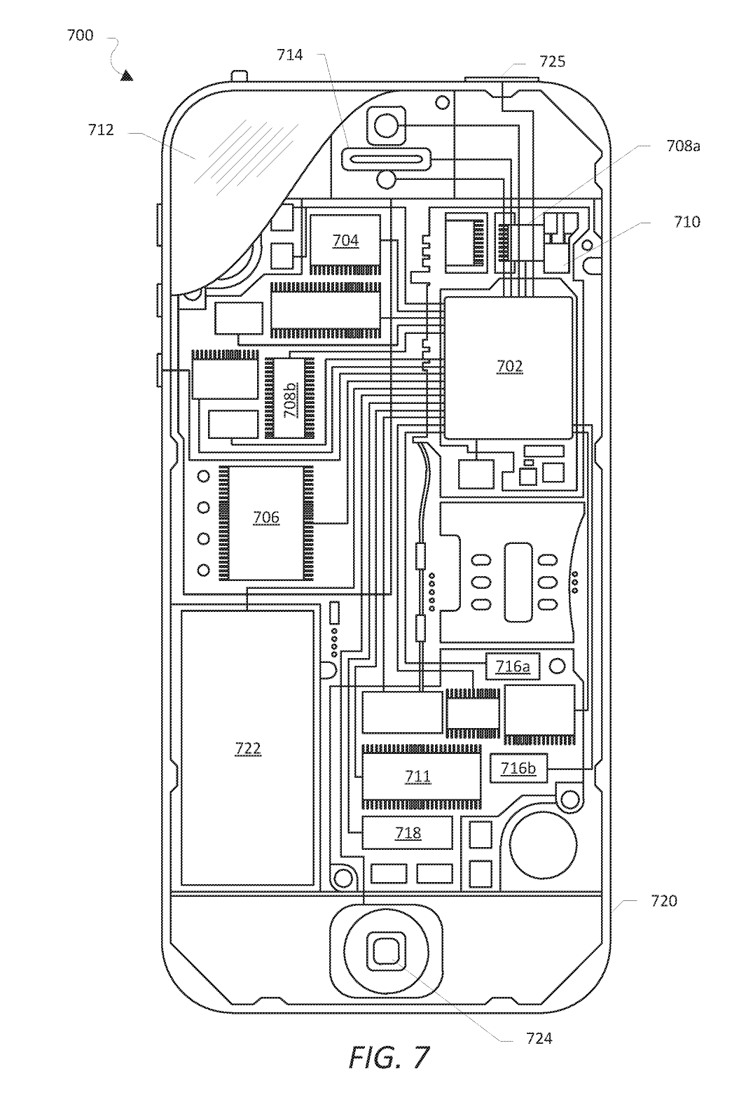

The various embodiments may be implemented in any of a variety of wireless communication devices 110 and 200, an example of which is illustrated in FIG. 7, as wireless communication device 700. As such, the wireless communication device 700 may implement the process and/or the apparatus of FIGS. 1A-6, as described herein.

With reference to FIGS, 1-7, the wireless communication device 700 may include a processor 702 coupled to a touchscreen controller 704 and an internal memory 706. The processor 702 may be one or more multi-core integrated circuits designated for general or specific processing tasks. The memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the wireless communication device 700 need not have touch screen capability.

The wireless communication device 700 may have one or more cellular network transceivers 708a, 708b coupled to the processor 702 and to at least one antenna 710 and configured for sending and receiving cellular communications. The transceivers 708a, 708b and antenna 710 may be used with the above-mentioned circuitry to implement the various embodiment methods. The cellular network transceivers 708a, 708b may be the RE resource 218. The antenna 710 may be the antenna 220. The wireless communication device 700 may include two or more SIM cards 716a, 716b, corresponding to SIM-1 204a (the first SIM) and SIM-2 204b (the second SIM), coupled to the transceivers 708a, 708b and/or the processor 702. The wireless communication device 700 may include a cellular network wireless modem chip 711 (e.g., the baseband modem processor 216) that enables communication via at least one cellular network and is coupled to the processor 702.

The wireless communication device 700 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not shown).

The wireless communication device 700 may also include speakers 714 for providing audio outputs. The wireless communication device 700 may also include a housing 720, constructed of a plastic, metal, or a combination of materials, for containing all or some of the components discussed herein. The wireless communication device 700 may include a power source 722 coupled to the processor 702, such as a disposable or rechargeable battery. The rechargeable battery may also be coupled to a peripheral device connection port (not shown) to receive a charging current from a source external to the wireless communication device 700. The wireless communication device 700 may also include a physical button 724 for receiving user inputs. The wireless communication device 700 may also include a power button 726 for turning the wireless communication device 700 on and off.

The various embodiments illustrated and described are provided, merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to use or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present method and apparatus.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present method and apparatus. Various modifications to these examples will be readily apparent to those skilled in the art, and the generic principles defined herein may be applied to some examples without departing from the spirit or scope of the method and apparatus. Thus, the present method and apparatus is not intended to be limited to the examples shown herein but is to be accorded the widest scope consistent with the following claims and the principles and novel features disclosed herein.

What is claimed is:

1. A method for a wireless communication device to manage registrations for a first Subscriber Identity Module (SIM) associated with a first subscription and a second SIM associated with a second subscription, the method comprising:
registering the first subscription to a first Public Land Mobile Network (PLMN), wherein the first PLMN is associated with at least one parameter;
identifying a second PLMN for the second subscription based on the at least one parameter; and
registering the second subscription to the second PLMN.

2. The method of claim 1, wherein identifying the second PLMN based on the at least one parameter comprises:
determining at least one candidate PLMN for the second subscription; and
selecting the second PLMN from the at least one candidate PLMN based on the at least one parameter.

3. The method of claim 2, wherein one or more of the at least one candidate PLMN is determined while registering the first subscription to the first PLMN.

4. The method of claim 2, wherein the at least one candidate PLMN is determined from a list of currently available PLMNs, wherein the list of currently available PLMNs comprises one or more of a Home PLMN (HPLMN) or Registered PLMN (RPLMN).

5. The method of claim 2, wherein selecting the second PLMN from the at least one candidate PLMN based on the at least one parameter comprises determining whether any of the at least one candidate PLMN is associated with the at least one parameter.

6. The method of claim 5, wherein selecting the second PLMN from the at least one candidate PLMN based on the at least one parameter further comprises selecting one of the at least one candidate PLMN as the second PLMN, wherein the second PLMN is associated with the at least one parameter.

7. The method of claim 6, wherein selecting the second PLMN from the at least one candidate PLMN based on the at least one parameter further comprises suspending cell search for the at least one candidate PLMN other than the second PLMN in response to determining that the second PLMN is associated with the at least one parameter.

8. The method of claim 5, wherein selecting the second PLMN from the at least one candidate PLMN based on the at least one parameter further comprises searching for at least one additional candidate PLMN in response to determining that none of the at least one candidate PLMN is associated with the at least one parameter.

9. The method of claim 8, further comprising suspending searching for the at least one additional candidate PLMN in response to finding an additional candidate PLMN associated with the at least one parameter.

10. The method of claim 9, further comprising setting the additional candidate PLMN associated with the at least one parameter as the second PLMN.

11. The method of claim 5, further comprising selecting a first candidate PLMN as the second PLMN in response to determining that the first candidate PLMN and a second candidate PLMN of the at least one candidate PLMN are associated with the at least one parameter.

12. The method of claim 11, wherein the first candidate PLMN has a higher signal quality than that of the second candidate PLMN.

13. The method of claim 11, wherein the first candidate PLMN is a Home PLMN (HPLMN) associated with the second subscription and the second candidate PLMN is not the HPLMN associated with the second subscription.

14. The method of claim 11, further comprising selecting the second candidate PLMN as the second PLMN in response to determining that registration to the first candidate PLMN has failed.

15. The method of claim 1, further comprising determining the at least one parameter associated with the first PLMN in response to completing registration of the first subscription to the first PLMN.

16. The method of claim 1, wherein the at least one parameter comprises a first Mobile Country Code (MCC).

17. The method of claim 16, wherein the second PLMN is associated with the first MCC.

18. The method of claim 1, wherein the first PLMN and the second PLMN are different PLMNs.

19. The method of claim 1, further comprising activating the wireless communication device in response to power-on or disabling an airplane mode.

20. The method of claim 19, wherein the first subscription is registered to the first PLMN in response to activating the wireless communication device.

21. A wireless communication device, comprising:
at least one radio frequency (RF) resource;
a processor operably connected to said RF resource and configured to connect to a first Subscriber Identity Module (SIM) associated with a first subscription and to a second SIM associated with a second subscription, and configured to:
register the first subscription to a first Public Land Mobile Network (PLMN), wherein the first PLMN is associated with at least one parameter;
identify a second PLMN for the second subscription based on the at least one parameter; and
register the second subscription to the second PLMN; and
a memory operably connected to said processor.

22. The wireless communication device of claim 21, wherein the processor identifies the second PLMN based on the at least one parameter by:
determining at least one candidate PLMN for the second subscription; and
selecting the second PLMN from the at least one candidate PLMN based on at least one parameter.

23. The wireless communication device of claim 22, wherein the processor is configured to determine the at least one candidate PLMN from a list of currently available PLMNs, wherein the list of currently available PLMNs comprises one or more of a Home PLMN (HPLMN) or Registered PLMN (RPLMN).

24. The wireless communication device of claim 22, wherein the processor is configured to select the second PLMN from the at least one candidate PLMN based on the at least one parameter by determining whether any of the at least one candidate PLMN is associated with the at least one parameter.

25. The wireless communication device of claim 24, wherein the processor is configured to select the second PLMN from the at least one candidate PLMN based on the at least one parameter by selecting one of the at least one candidate PLMN as the second PLMN wherein the second PLMN is associated with the at least one parameter.

26. The wireless communication device of claim 25, wherein the processor is further configured to suspend search for at least one additional candidate PLMN in response to determining that the second PLMN is associated with the at least one parameter.

27. The wireless communication device of claim 24, wherein the processor is further configured to select a first candidate PLMN as the second PLMN based on one or more of signal quality in response to determining that the first candidate PLMN and a second candidate PLMN of the at least one candidate PLMN are associated with the at least one parameter.

28. The wireless communication device of claim 21, wherein he at least one parameter comprises at first Mobile Country Code (MCC).

29. A method for a wireless communication device to manage registrations for a first Subscriber Identity Module (SIM) associated with a first subscription and a second SIM associated with a second subscription, the method comprising:
determining a first Mobile Country Code (MCC) associated with a first Land Mobile Network (PLMN) on which the first subscription is registered;
selecting a second PLMN from a list of candidate PLMNs associated with the second subscription based on the MCC; and
registering the second subscription to the second PLMN before registering other candidate PLMNs from the list of candidate PLMNs.

30. A wireless communication device, comprising:
at least one radio frequency (RF) resource;
a processor operably connected to said RF resource and configured to connect to a first Subscriber Identity Module (SIM) associated with a first subscription and to a second SIM associated with a second subscription, and configured to:
determine a first Mobile Country Code (MCC) associated with a first Public Land Mobile Network (PLMN) on which the first subscription is registered;
select a second PLMN from a list of candidate PLMNs associated with the second subscription based on the MCC; and
register the second subscription to the second PLMN before registering other candidate PLMNs from the list of candidate PLMNs; and
a memory operably connected to said processor.
